(19) United States
(12) Patent Application Publication
(10) Pub. No.: US 2014/0059476 A1
(43) Pub. Date: Feb. 27, 2014

(54) METHOD OF SPREADING E-BOOK DISTRIBUTION THROUGH SHARING OF CHILDREN'S READING HISTORIES

(71) Applicant: Hyun-hee Shin, Yongin-si (KR)

(72) Inventor: Hyun-hee Shin, Yongin-si (KR)

(21) Appl. No.: 14/116,033

(22) PCT Filed: May 11, 2012
(86) PCT No.: PCT/KR2012/003715

§ 371 Date: Nov. 13, 2013

(30) Foreign Application Priority Data
May 17, 2011 (KR) 10-2011-0046178

(51) Int. Cl. G06F 3/0484

(52) U.S. Cl. CPC G06F 3/0484
USPC 715/776

(57) ABSTRACT

The present invention relates to a method of spreading E-book distribution through sharing of children's reading histories. The method of the present invention includes: (a) accessing by a first user terminal a reading community operating server; (b) purchasing or loaning by the first user terminal of an e-book; (c) displaying the book image data of the E-book on a page of the first user terminal; (d) updating reading history representation information for representing a book history of the first user terminal as a visual image; and (e) opening the reading history representation information of the first user terminal, and accessing by a second user terminal the reading community operating server in order to view the reading history representation information of the first user terminal.

### TECHNICAL FIELD

Current invention illustrates the method of E-book distribution through the network; particularly regarding children's reading histories.

### BACKGROUND ART

There is a steady increase in number of readers that reads with E-book by making use of multimedia devices such as tablet, PC, net book, electronic reader, smart phone among others. Many experts are predicting that the E-book industry will exceed that of the paper book in few years time.

Another report shows high growth rate of market for children's books wherein it is also reported to be taking up high percentage in the publishing industry. This phenomenon is due to the fact that parents have high interest regarding their children's reading habits. It also shows that elementary students have much higher rate when it comes to amount of books read.

It is probable that high percentage of consumers in the E-book market will consist of children in the near future. Therefore, it can be surmised that organized system needs to be set up for the young readers in their childhood years.

Effective reading methods are important for children as they lack the ability to understand knowledge deeply and also lack discernment when there is a need to filter the information. Further, types of relationship they develop while reading books together with other friends in their age group is also important. Voluntary reading sessions where they take active interest are also important instead of the involuntary and forced reading sessions. In this regard, reading sessions for children tend to always involve entertainment and fun related factors.

Furthermore, parents' attention and interests have significant effect when it comes to children's reading habits. However, it is hard to keep track of the types of books that children are reading and the areas that they need to improve on, as well as comparing the progress with other children in conventional reading session methods. For this to be possible, the parents had to keep track of the books and manage the progress which takes a lot of time and effort. It is also very difficult for the children to follow the set plans.

Embodiment of this invention is the result of the endeavors that seek to resolve these problems which are deeply rooted within the industry that had been previously mentioned.

### SUMMARY OF INVENTION

### Technical Problem

Accordingly, present invention's purpose is to provide the system of distributing the E-book that may in turn enhance the quality of children's reading experiences.

Another purpose of present invention is to create the reading history in the network which can be shared which in turn creates a social network on the internet.

Further, another purpose of this invention is to provide the method that will enable private educational institutions that rent books offline or teach essays and provide reading related education to join the individual's reading session related network. Through this, new market can be established as well as further improving the effects of reading.

On the other hand, other purposes of present invention will be stated hereinafter in details within the scope of inference.

### Solution to Problem

To accomplish the above object, present invention includes:
a. stage where first user's terminal accesses the operational server of reading community;
b. stage where first user's terminal purchases or loans the E-book;
c. stage where first user's terminal displays the image related data in its pages from the E-book mentioned above;
d. stage where reading history in first user's terminal is created as a visual format henceforth known as reading history representation; and
e. stage where reading history representation from first user's terminal is made public and where second user's terminal connects to the reading community's server to view the reading history representation of the first user are all included as its characteristics.

It is advised that E-book's corresponding cover image would be shown on Stage C as part of effectively sharing children's reading history and promoting E-book system in accordance with the present invention.

Further, it is also advised that terminal of the second user be linked as ‘buddies’ with first user's terminal as part of effectively sharing children's reading history and promoting E-book system in accordance with the present invention.

Further, reading history representation can also include the group's reading history for those who are linked as buddies.

As part of effectively sharing children's reading history and promoting E-book system in accordance with the present invention, it includes the stage where first user's terminal joins a certain Closed User Group, hereinafter known as CUG and that user's reading history information may be included in the CUG's group reading history representation.

Further, CUG can be created by business terminal and it may distribute the E-book to the users within the CUG by using E-book distributional module.

Further, reading history formulation module may check what user's terminal had purchased or borrowed in order to add the corresponding E-book where reading history representation information would be renewed as part of effectively sharing children's reading history and promoting E-book system in accordance with the present invention.

Further, methods regarding the effective sharing of children are reading history and promoting E-book system in accordance with the present invention are as follows:
a. stage where user's terminal is connected to the reading community's server;
b. stage where user's terminal creates reading session related events; and
c. stage where image data of the books that were included in the reading related events as mentioned above are shown, where this in turn renews the information regarding reading history representation that expands the space as well as shows the reading history in a visual format, and the stage where books shown in image data and reading history information is made public to the third party's terminal are all included as characteristics.

### Advantageous Effects of Invention

In accordance with the present invention, books that children read will be able to stand out visually. Further, it has the component of expanding in terms of space and that the reading history can be made public to other children which may generate more interest. Through the generated interest and spread of information, this in turn may promote the spread of children's E-book even further.

Further, as mentioned above, there is another advantage in the sense that social networks for the children can be formed online.

Further, it is advantageous for the parents as well in the sense that they can easily figure out the list of books that their children have read. Moreover, it is also possible for them to view other children's reading list which in turn helps the parents to guide their children in reading sessions.

Further, new business opportunities are presented wherein the private educational institutions that rent books offline or teach essays and provide reading related education could buy E-books in bulk for distribution purposes as they operate CUGs.

In addition, other possible effects of the present invention that are currently not mentioned in the specification will be considered as included in.

### BRIEF DESCRIPTION OF THE DRAWINGS

The preferred embodiments of the present invention will be described with reference to the accompanying drawings. These drawings depict only exemplary embodiments of the disclosure and are not therefore to be considered to be limiting of its scope.

FIG. 1 illustrates the general features of the system of the present invention.

FIG. 2 and FIG. 3 illustrates the drawing that shows the concept where the reading history related information from the user's terminal would be symbolized according to the present invention.

FIG. 4 illustrates the example of reading history representation according to the present invention.

FIG. 5 illustrates the example of service being provided through the drawing according to the present invention.

FIG. 6 illustrates the detailed formation of reading history management section from FIG. 5.

FIG. 7 illustrates the detailed formation of bulletin board in the drawing from FIG. 5

FIG. 8 illustrates the detailed formation of member management part from FIG. 5

FIG. 9 illustrates the detailed formation of buddy management in the drawing from FIG. 5

FIG. 10 illustrates the detailed formation of CUG management in the drawing from FIG. 5

FIG. 11 illustrates the detailed formation of E-book management in the drawing from FIG. 5

### DETAILED DESCRIPTION OF EXEMPLARY EMBODIMENTS

Present invention's basic principle is based on the user purchasing or borrowing the E-book through the terminal in accordance with the system which is based on the current invention with the purpose of effectively sharing children's reading history and promoting E-book system.

The term terminal as mentioned above may refer to one that the child is using or the terminal that parents are using with the child. However, it is not only based on purchasing or borrowing the E-book. Purchasing E-book is the best way to ensure the promotion and spread of E-book.

However, there are cases that E-book is distributed for free. Further, it is possible to make use of the current invention's system after purchasing E-book through other applications.

Application that has the function of the current invention may include purchasing and the distribution module for E-book. However, one of the most important embodiments of this application is to form and visually present the user's reading history. Further, reading history is presented to other users who are linked as buddies and to those who belong in the same CUG (Closed User Group) in a visual and spatial form. In this current invention, reading history is displayed on user's screen in visual and spatial form in layered format which is defined as reading history representation.

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure

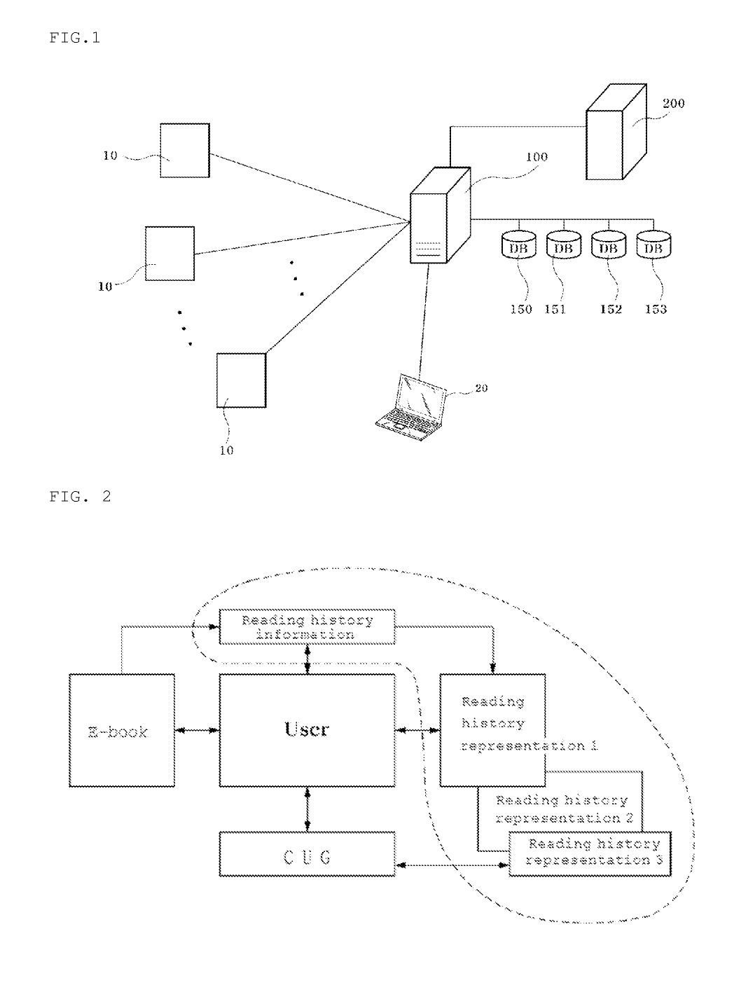

FIG. 1 illustrates general format of the current invention. User terminal 10 can connect to the reading community's server 100 through various networks. This network can be mobile phone network such as WCDMA or wireless internet network such as Wi-Fi, Wibro, Wimax and others such as hybrid between two networks. There are no restrictions as long as it can be connected to the terminal that can send and receive data.

There are various user terminals 10 within the system and this user terminal 10 can be registered with the child's account. Business terminal 20 can be used by a private educational institution that teaches essay or company that rents books offline as well as publication or reading related education related company. The reading community's server as mentioned above (100) have several databases 150, 515, 152, 153. The databases may include member's information database 150, reading material resources database 151, reading history database 153, and contents database 154.

Further, in another implementation, E-book database may be included in the external server 200 of the other e-book publishers. It is not specified but there may be several other databases as needed. For instance, there could be CUG database, payment related database log database among others.

In the member information database 150 as mentioned above can hold information such as member's account, game, age, grade, address and other personal information. In the reading material resources database 151, there are information such as name of the book, author's name, publication, ISBN and others as well as cover image data of the books. In the contents database, information that current invention provides such as contents in the bulletin board, stop motion/video contents and multimedia contents among others.

FIG. 2 illustrates the example of how reading history can be put into practical use with user as the main focus according to the present invention. User terminal can be used to purchase the E-book. In the exemplary case, application installed in the user terminal will have E-book viewer terminal. User terminal can be used to read the purchased E-book. Reading history can be renewed in the simplest way when the E-book is purchased and this event will be recorded. In a better scenario, user's terminal may record and renew as the reader finishes the entire book. Reading history includes the related book's information, purchased date or when the user has finished reading the book.

Current invention does not provide the reading history related information stored as it was mentioned above but in a form of reading history representation format that shows up in the user's terminal in visual or spatial format. Information regarding reading history can be shown in several layers. Some reading history information is about user's personal reading history and other reading history is about reading history of other users who belong to the same CUG where their reading history is joined with the user's reading history. In FIG. 2, the area that are in dotted lines is the one that will automatically run by the set program within the user's terminal based on the reading related events that took place in the user's terminal.

Reading related events that affect the reading history and the point that the information of reading history will be renewed can be decided in various points thereof. One good example of implementation is the point where user purchases the E-book. When the user purchased the E-book, the experience related to reading this book will be recorded in the system. In another implementation, reading related event is designated as the point when user borrows the E-book.

For this instance, time code that allows the user to read the corresponding E-book within a certain period is provided. This code is detected by the E-book viewer program wherein the viewer module is activated only within certain time period.

Another reading event in exemplary implementation is the point in time when the user has finished reading the corresponding E-book after borrowing or purchasing the book. In this case, the user's terminal checks if the user has finished reading the E-book before refreshing the information regarding the reading history.

In another implementation, reading related event can be defined when the user selects the book from the list and marks that it has been read. This has the disadvantage in the sense that it relies on user's honesty; however, this is the simplest method when it comes to managing the overall system.

FIG. 3 illustrates the layering stages of the reading history representation according to the present invention. When the user's terminal purchases the book and creates a reading event, reading community's operational server or the program module which is installed in the server refreshes the first reading history representation related information. When the user's reading history piles up, it renews it with second reading history representation in a more spacious area.

It is possible to form the separate page for first reading history page and second one to renew them at the same time. Both the first and the second reading history pages represent the user's individual reading history. In the case where the user had joined the CUG, third reading history representation is formed as the user joins in with the group's reading history. In this manner, it is possible to form a third reading history representation or it could also represent the group reading history where user has formed it with other users linked to him or her as buddies.

As it had been mentioned, reading history can be formed in various ways. Important part is that it can be visual and expands spatially at the same time. Table 1 illustrates the image format where invention's reading material can be formed in different layers.

TABLE 1

| | | Third |
|---|---|---|
| First Reading History | Second Reading History | Reading History |
| Representation | Representation | Representation |
| Book Tree: When the | Book Tree Orchard: | Book Mountain |
| reading event takes | Several book trees are | Range: Several |
| place, E-books' covers | created to form an | users' reading |
| are shown as fruits in | orchard. | histories are formed |
| the tree. | | into a mountain |
| | | range |
| Bookshelf: When the | Library: Several | Library: Several |
| reading event occurs, E- | bookcases with the books | users' reading |
| books' covers are shown | that had been read are | histories are formed |
| as arranged or placed on | either arranged or put in | into a library |
| the bookshelf. | place form a library. | |
| First visual image: When | Second visual image: | Third visual image: |
| the reading event takes | Second visual image is | Third visual image |
| place, it is provided as | provided as a template or | is provided as a |
| a template or several | several templates where | template or several |
| templates where user can | they can be selected by | templates where |
| choose one visual image | the user; they are bigger | they can be selected |
| to represent the reading | in terms of space than | by the user in which |
| history. | the first visual image. | it can represent the |
| | | visual reading |
| | | history |

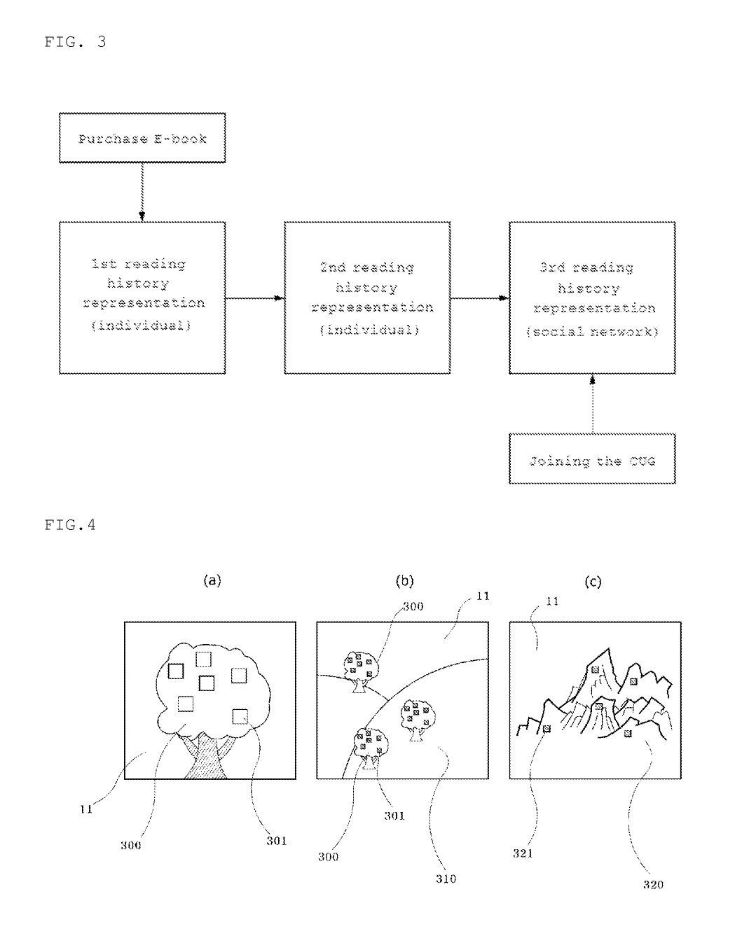

FIG. 4 illustrates layered reading history representation in the form of “Book Tree-Book Tree Orchard-Book Mountain Range. As seen in FIG. 4(a), when the reading related event takes place, image of the tree 300 as shown in the screen of the terminal 11 and the cover of the books 301 are hanging from the image of the tree 300 as fruits do. The covers of the book 301 can be specified as ‘Book Fruits’.

The numbers of fruit that can be hung from the tree are preset by the program. When the books that user have read exceeds the preset number, there will be no more fruits in the tree.

When there are too many fruit trees, cover image of the books cannot be seen from the user's screen as they become unrecognizably small thus this is not recommended. Thus, more the user reads, more images of the trees 300 will be formed and the book orchard 310 can also be formed.

This can be seen in FIG. 4(b).

On the other hand, FIG. 4(c) illustrates book mountain range (320) where the book covers that represent individual user's reading history is shown. When the book cover is selected, user's book history is provided.

As it had been mentioned above, reading history of the user can be expressed through the visual medium through the reading history representation. The users can have fun and interest in decorating their reading history. For instance, they may create the book orchard by planting the book tree. In case there are various items such as flowers, animals and the like, they can use these items to create a beautiful book orchard. Moreover, when the user clicks the cover image of the book 301 through the click or touch, related information regarding the corresponding E-book can be shown as it is magnified as well as the process where ‘buy’ button for purchase is activated so that other users can purchase the E-book right away.

Further, buddy relationship can be formed when one user likes the other user's book orchard, they can be their buddy in the same way as the social network. All the buddies' book orchards can be expressed as book mountain range and books that buddy read can be shared in real time.

For more effective book sharing between the buddies, new books that were read can be marked visually different. For instance, the book image can shine or glow.

Reading history representation and the related information can be made public and shared to the other users within the range where it is selected by the user or the server.

FIG. 5 illustrates the entire application's formation in form of a flowchart. For convenience sake, it had all been lumped into the point of view of a service provided but some application will be installed in the regular user's terminal, some in business terminal and other applications will be installed in the server. The reading history management 110, bulletin board 120, member management 120, buddy management 140, CUG management 160, and E-book management 170 are all included.

When the reading history is formed in the member management 130, reading history management 110 manages the reading histories and the reading histories are shared by the reading history management 110. Bulletin board 120 is where reading history representation can be put up so that people can befriend others where buddy management 140 takes care of the relationship. Moreover, buddy management can use the information and share the information of the books that have been read in real time. CUG management 160 manages the users that belong to CUG wherein in can include managing the users in the buddy relationship. Further, CUG management can distribute E-book as well. E-books can be bought by the individual through the E-book management 170 and CUG managers can buy them in bulks as well.

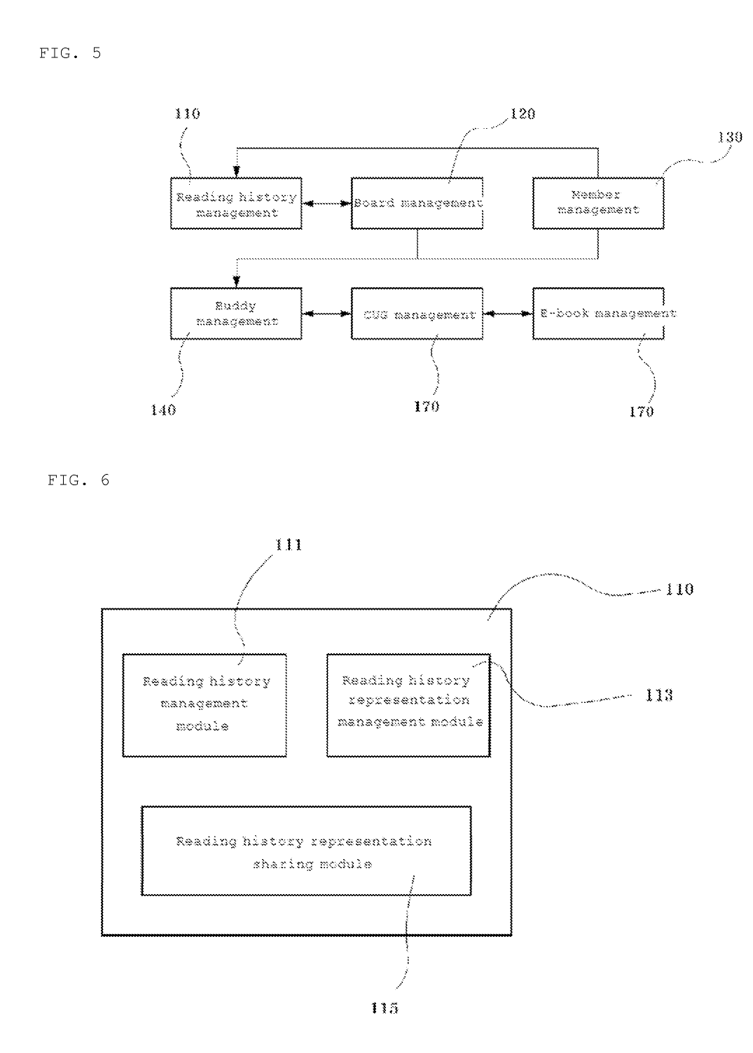

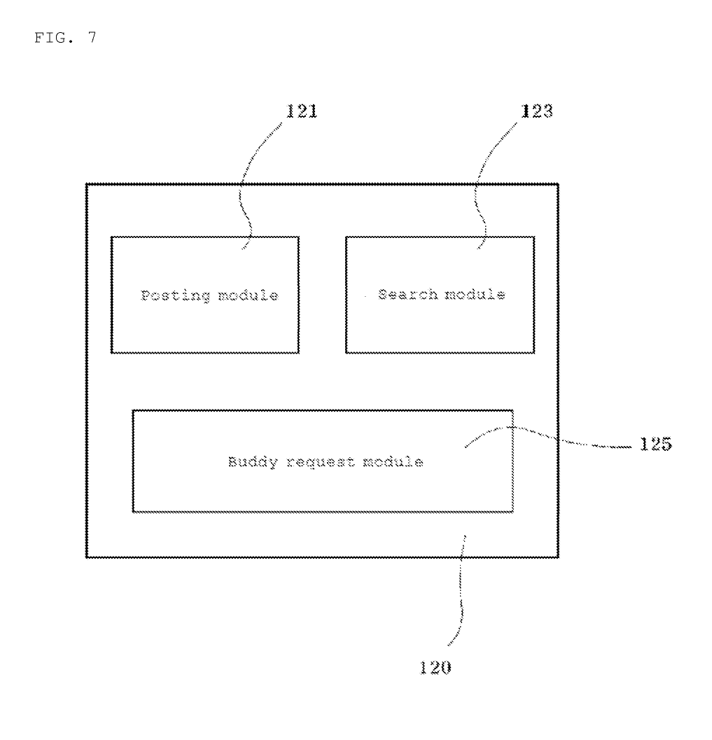

FIG. 6 illustrates the detailed formation of book history management 110 which includes reading history management module 111, book history representation management module 113 and reading history representation sharing module 115. This book history management 110 has an interface that users can control in the screen of the terminal. Reading history management module 111 can provide the means to manage the users' reading histories and book history representation management module 113 provide the method to manage the reading history representation. Reading history representation sharing module 115 can share the reading history to the third party users.

FIG. 7 illustrates the detailed parts of the board 120 which include posting module 121, search module 123 and buddy request module 125. Through the posting module 121, user's terminal can post personal reading history representations. Search module 123 can be used to search through various contents stored within the database. They can search for other users who read the same book and for the information regarding books. Buddy request module 125 is where the user can be linked to other users as buddies who are randomly suggested or as searched by the user.

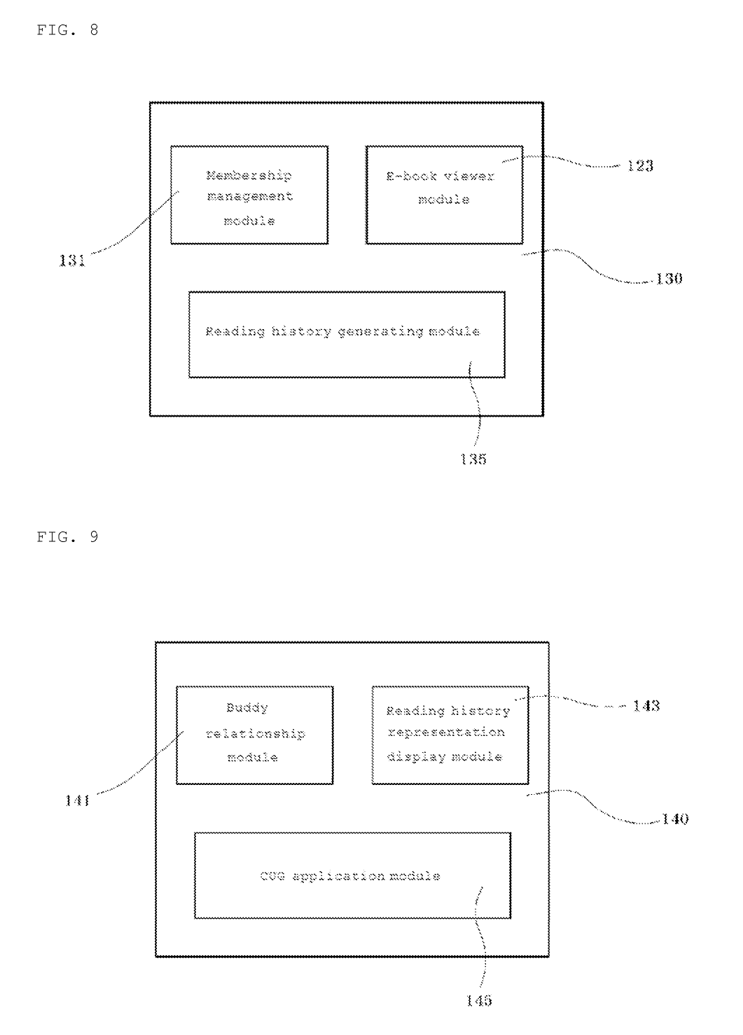

FIG. 8 illustrates the detailed formation of member management 130 which can be formed in the system's server that could include member management module 131, E-book viewer module 133 and reading history creating module 135 as well. Member management module 131 provides the user page that would be located for each user accounts. E-book viewer module 133 provides the method of viewing E-book in the user's terminal and can be installed in the user's terminal through the application. Reading history creating module 135 can seek out the reading related events as it happens in the user terminal. Through the E-book management 170, reading history can be formed where people purchase E-books. In other examples of implementation, when the user reads the E-book through E-book viewer module 133, reading history can be formed when the last page of the E-book is marked.

FIG. 9 illustrates the details regarding buddy management 140. Buddy management 140 includes buddy relationship module 141, reading history representation display module 143 and CUG application module 145. Buddy relationship module 141 manages the buddy relationship with other users. Reading history representation display module 143 manages the reading history representations that are made public to other users who are in buddy relationship. CUG application module 145 starts the registration process when the user terminal wishes to register as a member of specific CUG.

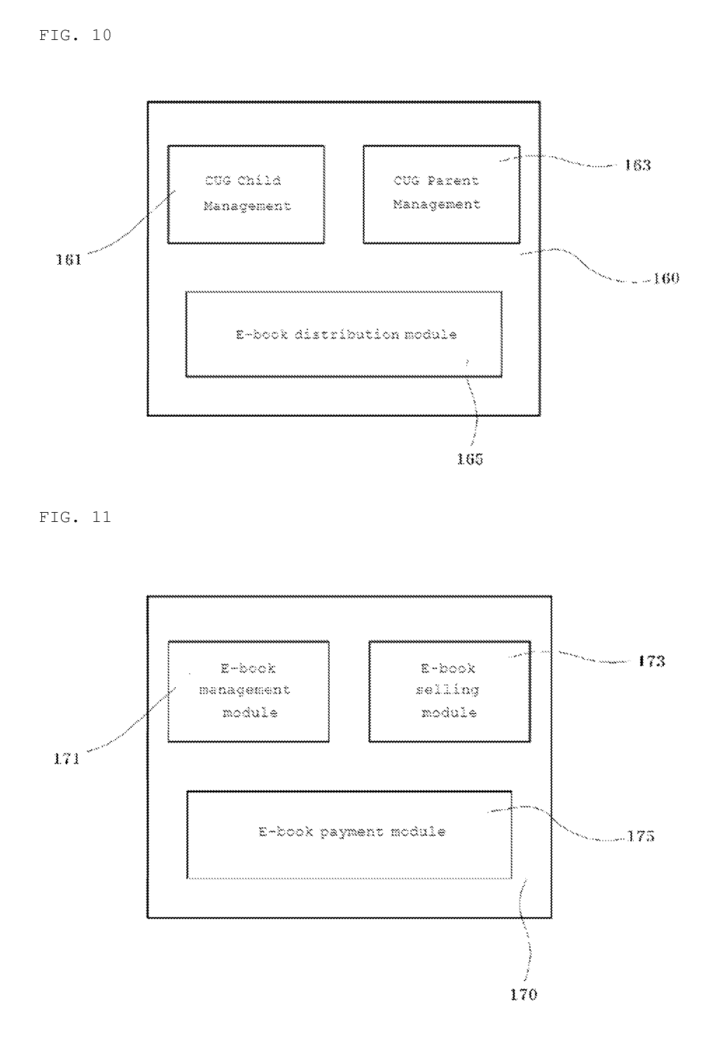

FIG. 10 illustrates detailed formation of CUG management 160 which includes CUG child management 161, CUG parent management 163, and E-book distribution module 165.

CUG management 160 has user interface which is displayed in the business terminal's screen.

CUG child management 161 manages the children who are registered in the corresponding CUG and help direct the child's reading sessions through the reading list posting function. For instance, when the child who is registered in the CUG has finished reading, there will be a book fruit in the book tree and the book information will be shared in real time with the buddies who are in the same CUG. CUG parent is the user using the business terminal and could act as the administrator of the CUG. Therefore, CUG parent can distribute the E-book after purchasing to the CUG child who has paid the membership fee.

FIG. 11 illustrates detailed formation of E-book management 170 which includes E-book management module 171, E-book selling module 173 and E-book payment module 175.

E-book management module 171 manages the E-books that system has and the E-book selling module 173 sells the E-book to the users who are logged in the system. E-book payment module 175 can work with the E-book distribution module 165 and balance the accounts.

The user terminals that are suitable to the current invention are smart phone, tablet PC, portable E-book reader and other mobile computing devices. However, devices such as notebook computer, net book and PC are not excluded. Moreover, specific embodiments thereof which are illustrated on this specification cannot limit the scope of protection for the current invention. Further, changes and replacements of the technical field also cannot limit the scope of protection for the current invention.

What is claimed is:

1. wherein effectively sharing children's reading history and promoting E-book system in accordance with the present invention divided into following stages:
a. stage where first user's terminal accesses the operational server of reading community;
b. stage where first user's terminal purchases or loans the E-book;
c. stage where first user's terminal displays the image related data in its pages from the E-book mentioned above;
d. stage where reading history in first user's terminal is created as a visual format henceforth known as reading history representation; and stage where reading history representation from first user's terminal is made public and where second user's terminal connects to the reading community's server to view the reading history representation of the first user.

2. wherein image data of the book that pertains to Stage C of claim 1 which corresponds to the cover of the E-book in part with effectively sharing children's reading history and promoting E-book system in accordance with the present invention.

3. wherein reading history representation that pertains to Stage D of claim 1 is composed of visual image that expands the space of the reading history; wherein it may include the information of first reading history representation and second reading history representation according to the size of the space as effectively sharing children's reading history and promoting E-book system in accordance with the present invention.

4. wherein second user terminal is in buddy relationship with first user terminal for effectively sharing children's reading history and promoting E-book system in accordance with the present invention which pertains to claim 1.

5. wherein reading history representation includes user terminal group's reading history linked as buddies for effectively sharing children's reading history and promoting E-book system in accordance with the present invention which pertains to claim 4.

6. wherein stage that first user terminal joins the Closed User Group is included and where information regarding reading history representation is included in part of effectively sharing children's reading history and promoting E-book system in accordance with the present invention which pertains to claim 1.

7. wherein Closed User Group can be created by business terminal which can distribute E-books to the users belonging to the group by making use of the E-book distribution module that reading community server provides as part of effectively sharing children's reading history and promoting E-book system in accordance with the present invention which pertains to claim 6.

8. wherein reading community server's reading history generating module checks the events related to reading for borrowed E-books and renew the reading history where the new E-books are added in which is a part of effectively sharing children's reading history and promoting E-book system in accordance with the present invention which pertains to claim 1.

9. wherein user terminals that have been mentioned above are mobile computing device in part of effectively sharing children's reading history and promoting E-book system in accordance with the present invention which pertains to claim 1.

10. wherein
a. stage where user's terminal is connected to the reading community's server;
b. stage where user's terminal creates reading session related events; and
c. stage where image data of the books that were included in the reading related events as mentioned above are shown, where this in turn renews the information regarding reading history representation that expands the space as well as shows the reading history in a visual format, and the stage where books shown in image data and reading history information is made public to the third party's terminal in part of effectively sharing children's reading history and promoting E-book system in accordance with the present invention which pertains to claim 1.
